(19) United States
(12) Patent Application Publication
(10) Pub. No.: US 2014/0048996 A1
(43) Pub. Date: Feb. 20, 2014

(54) Stabilizing Device

(71) Applicants: Roddy M. Bullock, Milford, OH (US); Paul Dennis Trokhan, Hamilton, OH (US)

(72) Inventors: Roddy M. Bullock, Milford, OH (US); Paul Dennis Trokhan, Hamilton, OH (US)

(21) Appl. No.: 13/587,507

(22) Filed: Aug. 16, 2012

(51) Int. Cl. B25B 11/00

(52) U.S. Cl. 269/289 R

(57) ABSTRACT

A stabilizing device. The device can have a generally planar, polygonal shape defined by edges forming a perimeter. The device has a vertical axis and a horizontal axis. The device further includes at least one ground-contact edge generally parallel to the horizontal axis, the ground-contacting edge being in contact with the ground when the device is in use, and at least three edges defining an open-ended slot, the slot being oriented generally parallel to the horizontal axis.

### FIELD OF THE INVENTION

This invention relates to a device for stabilizing work pieces for stable cutting, painting, sanding, welding, and the like.

### BACKGROUND OF THE INVENTION

When working with elongated materials or work pieces such as lumber, plastic or metal pipe, conduit, and the like, it is often desirable to elevate or otherwise support and hold secure a portion of such materials above a work surface, which can be the ground. For example, when cutting lumber with a circular hand saw, the circular saw blade protrudes through the backside of the lumber as the cut is being made. If the lumber is not elevated while sawing, the saw blade may bind or penetrate the surface upon which the lumber is situated. This may result in unwanted damage to the surface and cause potentially hazardous working conditions.

So-called “saw horses” are used to elevate work pieces for sawing, painting, sanding, welding, and the like. But saw horses can be bulky, heavy, and generally difficult to use in many situations. Also, saw horses do not secure a work piece against unwanted lateral movement during a cutting operation.

Attempts at solving this problem of bulkiness and adequate securing of a work piece include the place vise described in U.S. Pat. No. 7,772,019, issued May 25, 2010 to Losi, Jr. et al. (Losi). The Losi invention is simple, relatively lightweight, portable, and convenient. The Losi vise has closed apertures which can have shapes resembling the cross section of work pieces, and rests upon the ground or other work surface such that one end of the elongated member placed through a closed aperture and is supported over the work surface while the other end rests upon the work surface.

One problem with the Losi device is that one must “thread a needle” every time one wishes to cut a work piece. That is, the work piece must be inserted through a closed aperture of the Losi vise, an action that can be cumbersome if the work piece is relatively long, and impossible if the free end of the work piece cannot fit through the aperture, i.e., if a piece of wood has another piece of wood fastened to a free end.

There is a continuing unmet need for an easier to use stabilizing device for cutting or otherwise working on elongated work pieces.

### SUMMARY OF THE DISCLOSURE

A stabilizing device is disclosed. The device can have a generally planar, polygonal shape defined by edges forming a perimeter. The device has a vertical axis and a horizontal axis. The device further includes at least one ground-contact edge generally parallel to the horizontal axis, the ground-contacting edge being in contact with the ground when the device is in use, and at least three edges defining an open-ended slot, the slot being oriented generally parallel to the horizontal axis.

### BRIEF DESCRIPTION OF THE DRAWINGS

FIG. 1 is a perspective view of a prior art method for cutting elongated work pieces.

FIG. 2 is a perspective view of a prior art method for stabilizing elongated work pieces.

FIG. 3 is a perspective view of a stabilizing device of the present invention in use.

FIG. 4 is a perspective view of a stabilizing device of the present invention.

FIG. 5 is a front elevation view of an embodiment of the stabilizing device of the present invention.

FIG. 6 is a front elevation view of an embodiment of the stabilizing device of the present invention.

FIG. 7 is a side elevation of a stabilizing device of the present invention in an in-use configuration.

FIG. 8 is a plan view of a stabilizing device of the present invention in an in-use configuration.

FIG. 9 is a front elevation view of an embodiment of the stabilizing device of the present invention.

FIG. 10 is a front elevation view of an embodiment of the stabilizing device of the present invention.

FIG. 11 is a schematic block diagram of a computer operable to execute the disclosed invention.

FIG. 12 is a perspective view of a stabilizing device of the present invention in use.

FIG. 13 is a front elevation view of a portion of an embodiment of the stabilizing device of the present invention.

FIG. 14 is a perspective view of an embodiment of a stabilizing device of the present invention.

FIG. 15 is a front elevation view of an embodiment of the stabilizing device of the present invention.

FIG. 16 is a front elevation view of a portion of an embodiment of the stabilizing device of the present invention.

FIG. 17 is a front elevation view of an embodiment of the stabilizing device of the present invention.

FIG. 18 is a front elevation view of an embodiment of the stabilizing device of the present invention.

FIG. 19 is a cross-sectional view of Section 19-19 in FIG. 18.

FIG. 20 is a front elevation view of an embodiment of the stabilizing device of the present invention.

FIG. 21 is a front elevation view of an embodiment of the stabilizing device of the present invention.

FIGS. 22 A-C are cross-sectional views of Section 22-22 in FIG. 21.

FIG. 23 is a front elevation view of an embodiment of the stabilizing device of the present invention.

FIG. 24 is a front elevation view of an embodiment of the stabilizing device of the present invention.

FIG. 25 is a front elevation view of an embodiment of the stabilizing device of the present invention.

FIG. 26 is a cross-sectional view of Section 26-26 in FIG. 25.

FIG. 27 is a partial side view of an embodiment of the stabilizing device of the present invention.

FIG. 28 is a partial side view of an embodiment of the stabilizing device of the present invention.

FIG. 29 is a front elevation view of an embodiment of the stabilizing device of the present invention.

FIG. 30 is a front elevation view of an embodiment of the stabilizing device of the present invention.

### DETAILED DESCRIPTION OF THE INVENTION

The device of the present invention can be used to stabilize an elongated work piece for safe, more secure cutting, painting, welding, sanding, or other manipulation. The disclosure herein will focus on cutting wood, as with a hand-held circular saw, but the invention is not limited only to cutting, wood, or circular saws.

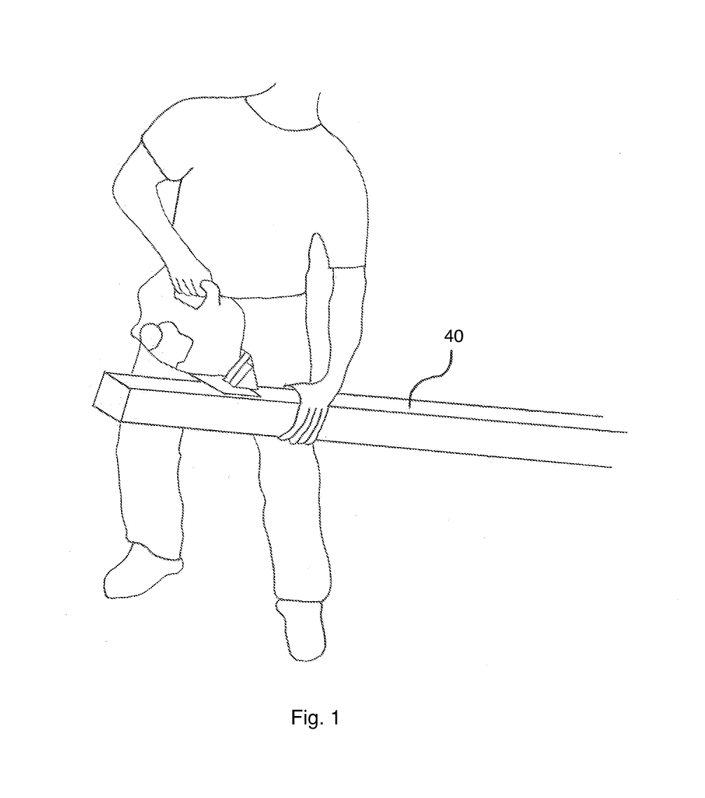

FIG. 1 shows a prior art method for stabilizing an elongated work piece 40 in the form of a piece of lumber. Work piece 40 is held with one hand, perhaps resting on the worker's knee or thigh, and cut with a circular saw held in the other hand. Clearly this method is unsafe and prone to inaccurate cuts.

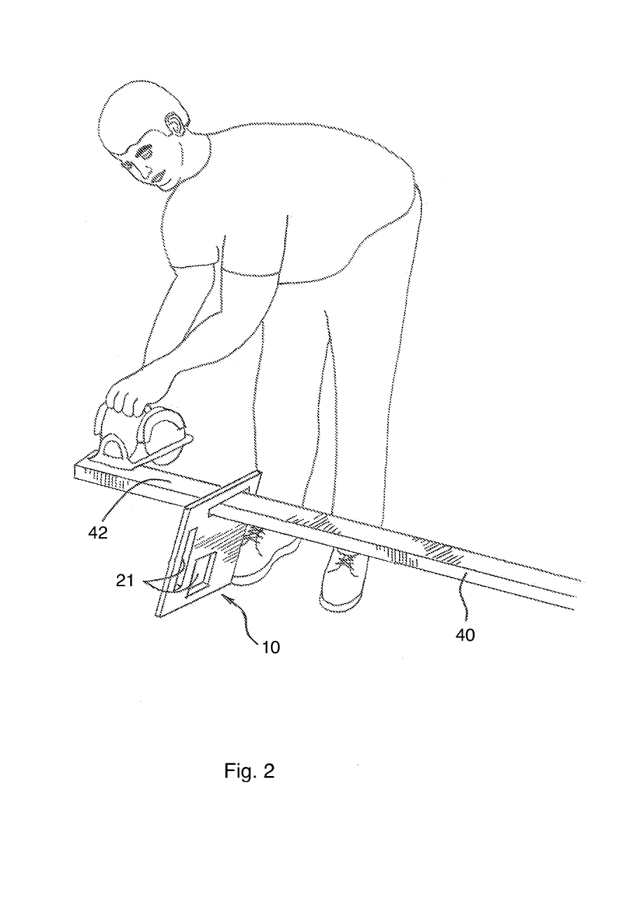

FIG. 2 shows a plate vise as taught in U.S. Pat. No. 7,772,019, issued May 25, 2010 to Losi, Jr. et al. (Losi), which is hereby incorporated herein by reference for all its enabling teaching on materials, methods of manufacture, theories of operation, work piece types, sizes, and general problem/solution disclosure. As shown in FIG. 2, Losi operates on a principle of incorporating shaped, closed apertures through which a similarly shaped work piece can be inserted. Once inserted, the plate vise, work piece, and ground form a stable triangle, in which the plate vise binds the work piece in a stabilized hands-free configuration.

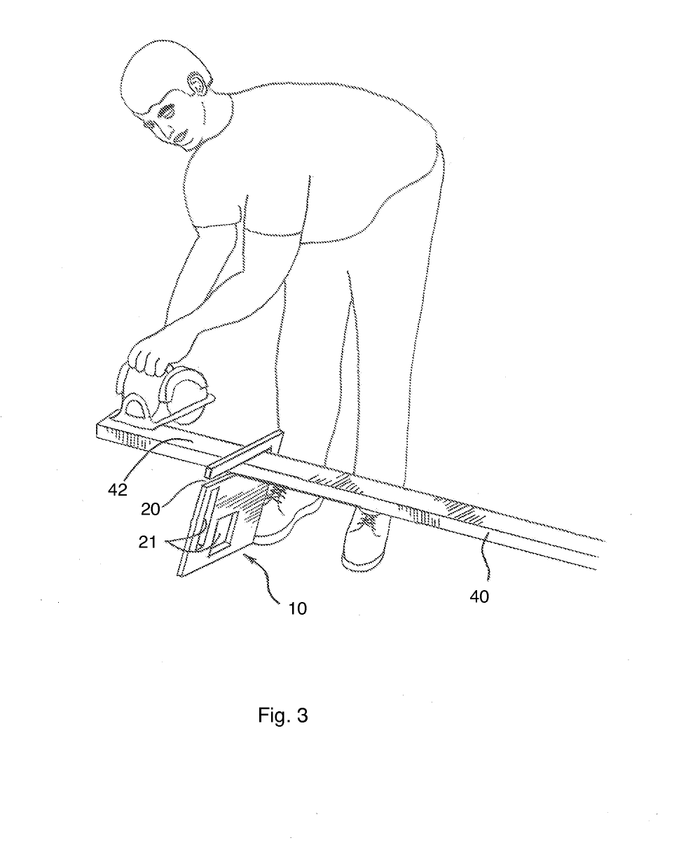

FIG. 3 shows a stabilizing device 10 of the present invention. A comparison with FIG. 2 highlights the inventive change, i.e., the incorporation of a suitably sized open-ended slot 20 instead of a closed aperture. This simple yet unintuitive and profound modification transforms a relatively cumbersome, limited-use device into an easy to use, versatile device. Therefore, the stabilizing device 10 of the present invention operates on the same principle of Losi's plate vise, but because it uses at least one slot instead of a closed aperture, it permits much easier operation and allows manipulation of more types of work pieces. Rather than “thread a needle” each time a work piece needs cutting, painting, etc., a worker need only slide the work piece (which may be encumbered on each free end) sideways into the slot 20.

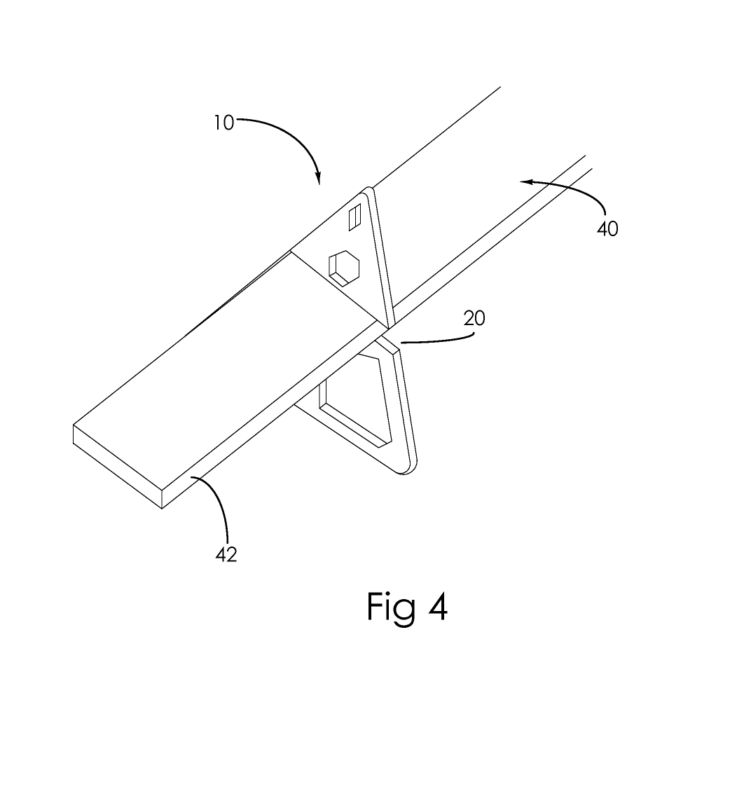

FIG. 4 shows another embodiment of the present invention. FIG. 4 shows a generally triangular-shaped stabilizing device 10 having an open-ended slot 20 into which a work piece 40 is inserted. As shown in FIGS. 3 and 4, the stabilizing device of the present invention can have closed apertures, as taught by Losi, but the stabilizing device of the present invention includes at least one open-ended slot. In some embodiments, the stabilizing device of the present invention has no closed apertures intended for use as work piece stabilizers as taught by Losi.

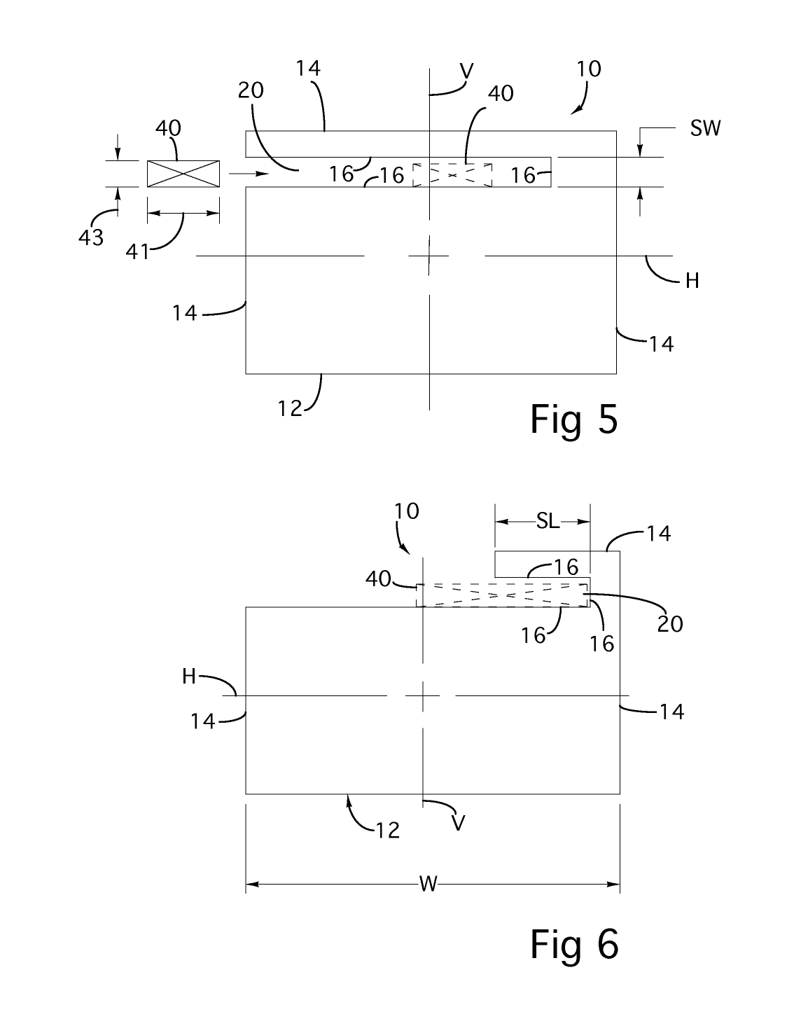

The invention will now be described in more detail to more clearly describe its features and advantages. As shown in FIGS. 5 and 6, stabilizing device 10 in a most simple form has a generally planar, polygonal shape defined by edges forming a perimeter. The term “generally planar” is not intended to mean “perfectly planar” or intended to mean any particular level of flatness, smoothness or stackability. The term “generally planar” is used to mean that in its simplest form the stabilizing device of the present invention is substantially flat with two broad sides and a plurality of side edges defining a polygonal shape. The generally planar device can be planar, as in a shaped steel plate, but may, however, have texture, three-dimensional features, bumps, ridges, and the like as long as its overall shape and impression is that of a two-sided, polygonal-shaped device.

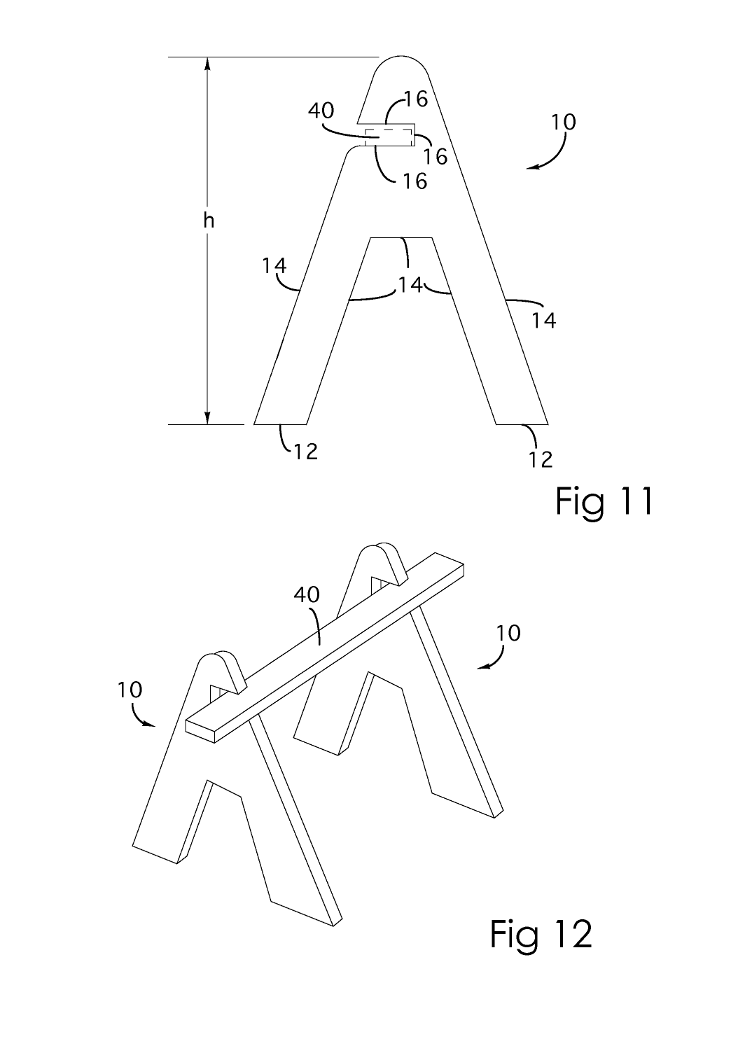

The term “polygonal” with respect to the shape of device 10 is intended to refer to the overall impression defined by the outside edges of device 10 which overall impression can be that of a square, rectangle, octagon, triangle, triangle with legs, and the like. Of course, the edges can incorporate general design principles and have some rounded corners, smooth transitions, and the like, and still be polygonal in overall shape. For example, the stabilizing device disclosed below with respect to FIGS. 11 and 12 have rounded top edges, but the overall shape of the device, including the edges defining the open-ended slot are nevertheless polygonal.

Polygonal includes “substantially polygonal” and “generally polygonal.” A device can be “substantially polygonal” when it has virtually no non-linear edges, such as the shapes shown, for example, in FIGS. 3, 4, 5 and 6. A device can be described as “generally polygonal” when at least about 50% of its side edges are linear, such as the shapes shown, for example, in FIGS. 11, 12, 13, 15, 29, and 30.

As shown in FIG. 5, stabilizing device 10 can be a plate-like form having two faces opposite one another, and generally rectangular in shape when viewed in a side elevation view. As depicted in FIG. 5, device 10 can have a vertical axis V and a horizontal axis H. Axes V and H are helpful in the description for orienting various features of device 10 when oriented in its intended use position. Horizontal axis H is intended to be generally parallel to the ground 25 or other work surface when device 10 is used. Thus, a bottom edge 12 forms one side of the polygonal shape, can be parallel to a horizontal axis H, and can be a side intended to rest on the ground when the device is used. Bottom edge 12 can be generally straight across the entire width W as indicated in FIG. 6. Bottom edge 12 can also have legs or projections that aid in stability on uneven ground or work surface.

For simplicity, axes V and H are not shown in all subsequent drawings in this description, but it is understood that the stabilizing devices of the present invention have such axes, and for front elevation views herein, axes V and H, although not shown, have the orientation as depicted in FIG. 5. It is recognized, however, that certain embodiments can have various orientations with respect to the ground when in use, and for each given in-use orientation, the vertical axis V is generally perpendicular to the ground and the horizontal axis H is generally parallel to the ground (or other work surface). Also not shown, but understood, is that the open-ended slot described below can have a longitudinal axis oriented lengthwise and parallel with the overall lengthwise orientation of the slot.

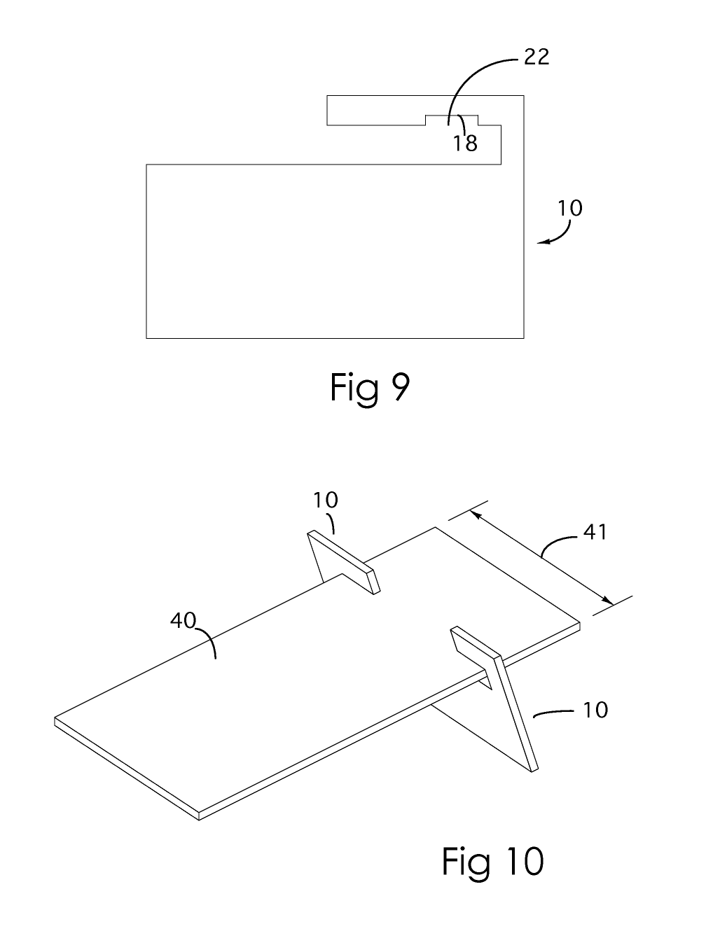

Other edges 14 define additional edges of polygonal shaped device 10. As shown in FIG. 5, however, at least three edges 14 designated as edges 16 of device 10 can define open-ended slot 20. An open-ended slot is distinguished from a closed aperture in that the edges 16 do not meet to form an enclosed aperture, i.e., at least two edges 16 of slot 20 meet only one other edge 16. In a three-sided slot, at least two opposing edges 16 of the three can be parallel. “Parallel” includes substantially exactly parallel, in which is meant two sided intended to be exactly parallel, and “generally parallel,” by which is meant that two opposing edges 16 can be parallel to within about 10 to 30 degrees of one another. Also, being parallel or generally parallel does not rule out having a notch of the type shown below with respect to FIG. 9. Open-ended slot has a slot width SW and a slot length SL. The slot width SW can be the average distance between opposing edges 16. The slot length SL can be the length of the shorter of the two opposing edges 16 (if they are not equal length). In general, the opening of slot 20 can be sufficient for a work piece to be freely inserted into the slot 20.

Stabilizing device 10 can be made from a relatively strong, rigid material such as aluminum or other metal alloy, metal, including stainless steel, steel, iron, or composite, plastic, such as PVC, HDPE, high-impact polymer, or other material that allows the user to exert downward force upon device 10 while the work piece is supported by device 10. Device 10 can be fabricated from relatively thin, lightweight plate material such that it is easily portable. Slots 20 can be formed by any means known in the art, including cutting, shearing, molding (in the case of molded plastic), grinding, or machining.

As shown in FIGS. 5 and 6, in operation, a user merely slides a work piece 40 into slot 20. Slot width SW can be a dimension slightly larger than a thickness dimension 42 of a work piece to be stabilized. In an embodiment, slot width SW can be about 10%, 20%, 30%, or 40% greater than a width dimension of the work piece 40. Slot width SW can be about ⅛ inch to about ½ inch greater than the greatest thickness dimension 43 of the portion of the work piece inserted into slot 20. For cutting standard US 2×4's, for example, slot width SW can be from 1⅝ inch to about 2 inches; for cutting standard US 1×4's, slot width SW can be from about ⅞ inch to about 1.25 inches, etc.

Slot length SL need not be equal to or greater than the width dimension 41 of the portion of the work piece 40 inserted into slot 20. As shown in FIG. 6, slot length SL can be sized such that only a portion of work piece 40 is in slot 20. Without being bound by theory it is believed that slot length SL should be from about 20% to about 150% of the width dimension 41 of the work piece 40 for best stabilization of work piece 40. The range of from 20% to 150% can include every integer value between 20 and 150, and every range bounded by any two of the integer values.

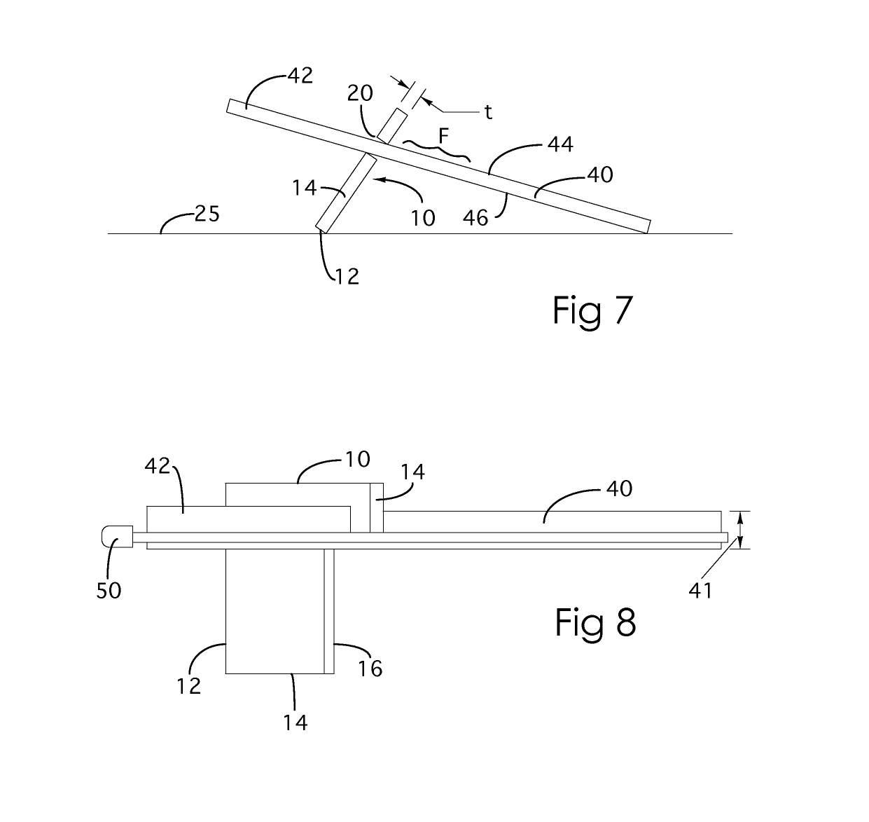

FIG. 7 is a side elevation view of stabilizing device 10 in use. As shown, device 10 can have a thickness t which can be uniform, as when plate steel is used, or can be an average thickness t if thickness varies across device 10, as when injection molded high-impact plastic with three-dimensional strength-improving features is used. Taking t to be an average thickness, t can be from about ⅛ inch to about 2 inches. Bottom edge 12 of device 10 can rest on the ground 25 (or other suitable work surface). One end of work piece 40 likewise rests on the ground 25 at an incline, with a distal end 42 thereof being elevated in a cantilevered configuration due to the binding and stabilizing effect of device 10 leaning such that a portion of top edge 16 of slot 20 engages a portion of top surface 44 of work piece 40, and a portion of bottom edge 16 of slot 20 engages a portion of bottom surface 46 of work piece 40. The skilled person can readily appreciate the stabilizing effect of the working position of stabilizing device 10.

Cantilevered distal end 42 of work piece 40 can be cut, painted, welded, sanded, and the like relatively safely and without interference. If additional stabilization is needed, a worker can apply pressure, for example, with his foot, on work piece 40 in the area generally denoted as F on FIG. 7.

FIG. 8 shows a top plan view of stabilizing device 10 positioned for use. As shown, device 10 can have a slot length SL less than the width dimension 41 of work piece 40. This has a distinct advantage that a worker can use a tape measurer 50 as shown, and run the tape measurer 50 unobstructed along the length of work piece 40 to make accurate measurements for cutting and the like.

FIG. 9 shows another embodiment of stabilizing device 10 in which an additional notch, slot, or other cut-away 22 is on top edge 16. Notch 22 can be defined by edge 18, which can be a single edge in an arc shape, or multiple edges in a more “squared-off” notch or the like. Notch 22 permits a worker to pass the tape of a tape measurer through the stabilizing device 10 to be able to make accurate measurements to a work piece when in the in-use configuration.

In an embodiment, notch 22 can be generally angular, as in triangular-shaped, as shown in FIG. 15, such that notch 22 can be used to stabilize rounded work pieces 40, such as pipes. Slot width SW can be a dimension greater than an outside diameter of a pipe, such that a pipe can be inserted into slot 20 and positioned such that in use notch 22 engages a top portion of a pipe or a pipe-shaped work piece 40.

One distinct advantage of the stabilizing device of the present invention is its ability to handle work pieces having relatively large width dimensions 41. As shown in FIG. 10, if a width dimension is too large for one stabilizing device 10, more than one stabilizing device 10 can be used. Two devices 10 are shown in FIG. 10, but it is to be understood that more than two can be used. For example, four devices 10 could be utilized in a similar manner to that shown in FIG. 10 such the entire work piece 40 is off the ground. This could be helpful if the work piece was to be used as a table or otherwise needing to be completely off the ground. Another version of device 10 for use as, in effect, table legs, is shown in FIG. 30 below.

In an embodiment, stabilizing device 10 can be configured as shown in FIG. 11. A device as shown in FIG. 11 can have a height h, of from about 6 inches to about 4 feet, including every 1-inch increment in between. In one embodiment, two stabilizing devices 10 as shown in FIG. 11 can be used together to make a saw horse or portable barrier, as shown in FIG. 12. A saw horse made from two stabilizing devices 10 can hold a work piece horizontally at a height of about 2 to 4 feet, thereby making a convenient support surface, as is known in the art of saw horses.

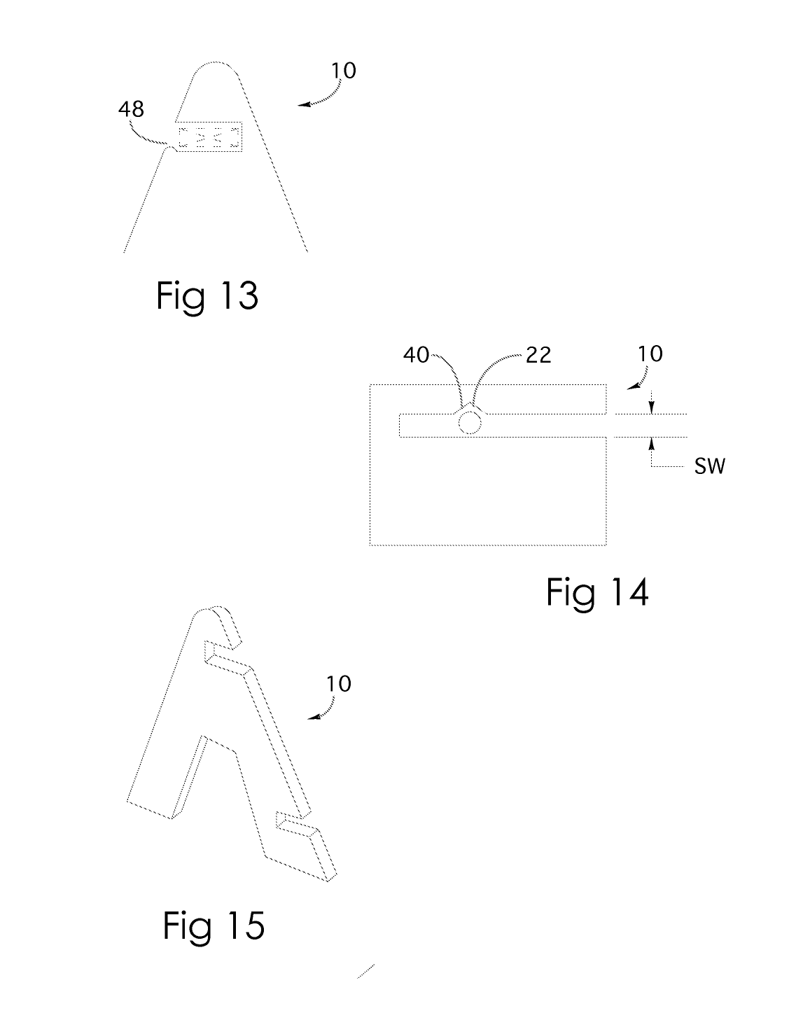

Many variations can be envisioned for stabilizing devices 10 of the present invention. For example, as shown in FIG. 13, a raised element 48 can be included to help prevent unwanted lateral (i.e., horizontal) movement of a work piece out of slot 20. Raised element can be a molded ridge, a machined hump, or any other raised projection as can be made by means known in the art of plastics or metal manufacture. Further, in certain embodiments of stabilizing device 10 suitable for use as components of saw horses, as shown in FIG. 12, stabilizing device 10 can have one or more additional slots for added stability. For example, in FIG. 14, stabilizing device 10 has an additional slot near the bottom of one of the legs of device 10, which slot, when used to hold a piece wood or other elongated member, can provide additional saw horse (or barrier) stability.

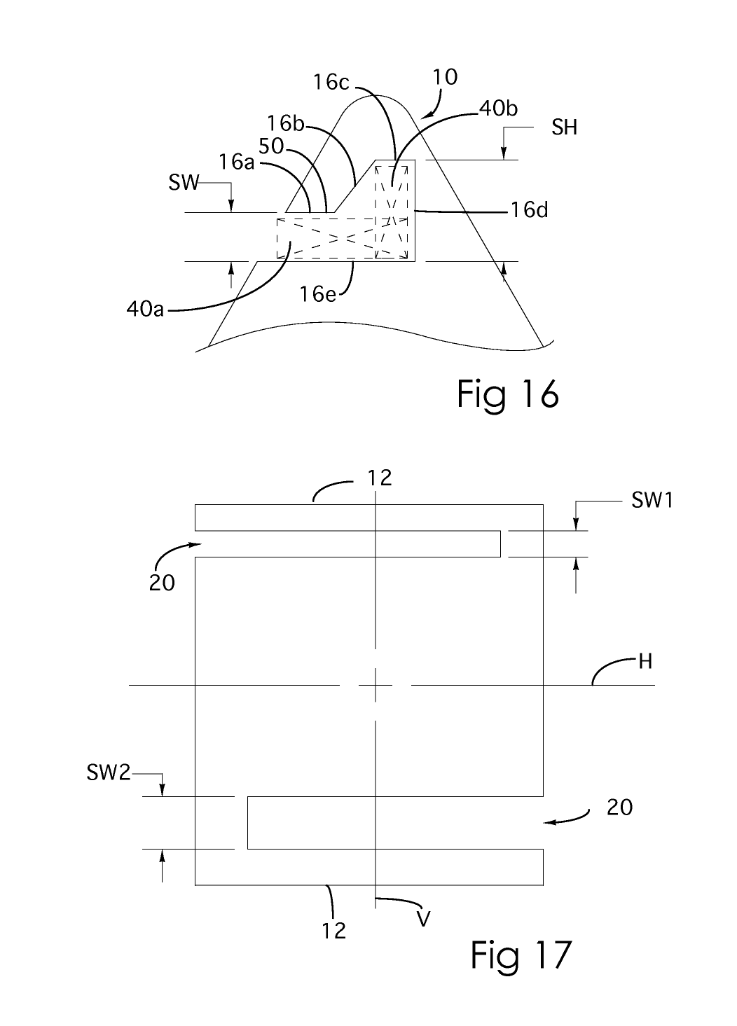

As shown in FIG. 16, stabilizing device 10, particularly in a configuration suitable for use as a component of a saw horse or barrier, can have a slot that accommodates a rectangular cross-section work piece in two orientations. Slot 20 has an entry portion that is like ordinary slot 20 as shown in FIG. 5, for example, having spaced apart parallel edges shown in FIG. 16 as edges 16a and 16e. But in a dual-mode configuration, slot 20 has more than 3 sides, with a transition zone 50 dividing a horizontal edge 16a with a sloping edge 16b. Edge 16b transitions to a horizontal edge 16c that can have a length slightly larger than a height 42 of a work piece 40. Edge 16c can transition to a edge 16d, which can have a length defining a slot height SH which can be slightly larger than a width 41 of a work piece 40. As shown in FIG. 16, such a stabilizing device 10 permits a dual mode of operation. A work piece 40 can be either oriented substantially flat 40a, or rotated into a substantially vertical 40b orientation.

In an embodiment, stabilizing device 10 can have more than one slot 20, or one slot 20 with multiple slot widths SW. In either configuration, device 10 can accommodate more than one size of work piece. For example, FIG. 17 shows an embodiment having a slot on two portions of stabilizing device 10. As depicted in FIG. 17, either of two edges can be considered edge 12 intended to rest on ground 25 when in use, and the choice depends on which of two slots 20 one wishes to use. For example, one slot can have a slot width 1, SW1, suitable for cutting “1×4's” (or 1×2's, 1×6's, etc.) and the other slot can have a slot width 2, SW2, suitable for cutting 2×4's” (or 2×6's, 2×8's, etc.). In a similar manner, stabilizing device 10 can have slots near all four (or more) edges. In either a two-edged, three-edged, four-edged, or more version, the edge opposite and furthest from a slot intended to be used can be “bottom” edge 12 parallel to a horizontal axis H.

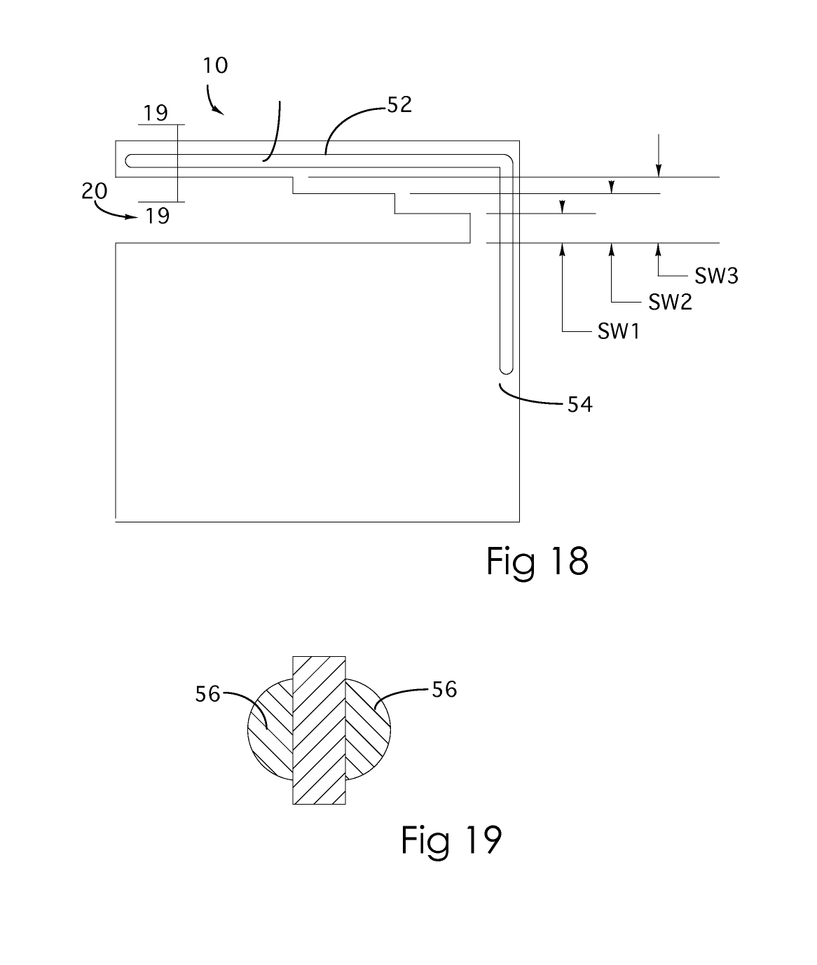

A further example of a device able to handle various work piece dimensions is shown in FIG. 18. As shown, stabilizing device 10 can have a slot 20 having a stepped, or variable slot width SW. Three slot widths SW are shown in FIG. 18, but it is clear that 2, 4, 5 or more slot widths could equally be employed.

Varying slot widths permit a single device 10 to accommodate different sizes of work piece. For example, as shown in FIG. 18, slot width 1 SW1 could be sized to handle “5/4 inch” deck lumber. SW1 could be about 1½ inches, for example. Slot width 2 SW2 could be sized to handle “2×4's” (or 2×6's, 2×8's, etc.) and could be about 1¾ inches, for example. Further, slot width 3 SW3 could be sized to handle “4×4's” and the like, and could be about 3½ inches, for example.

To help avoid unwanted distortion during use, a stabilizing device 10 can have reinforcing members 56 on stressed portions, such as top region 52 or side region 54, as shown in FIG. 18. Reinforcing members can be molded into the device for injection molded plastic devices 10, or cast, welded, or machined in/on for metal devices 10. Reinforcing members 56 can be in the form of a raised ridge and can provide bending resistant rigidity, thereby helping prevent bending of the portion of device 10 that is stressed during use, for example, the portion of device 10 above the slot 20 when the device is in use.

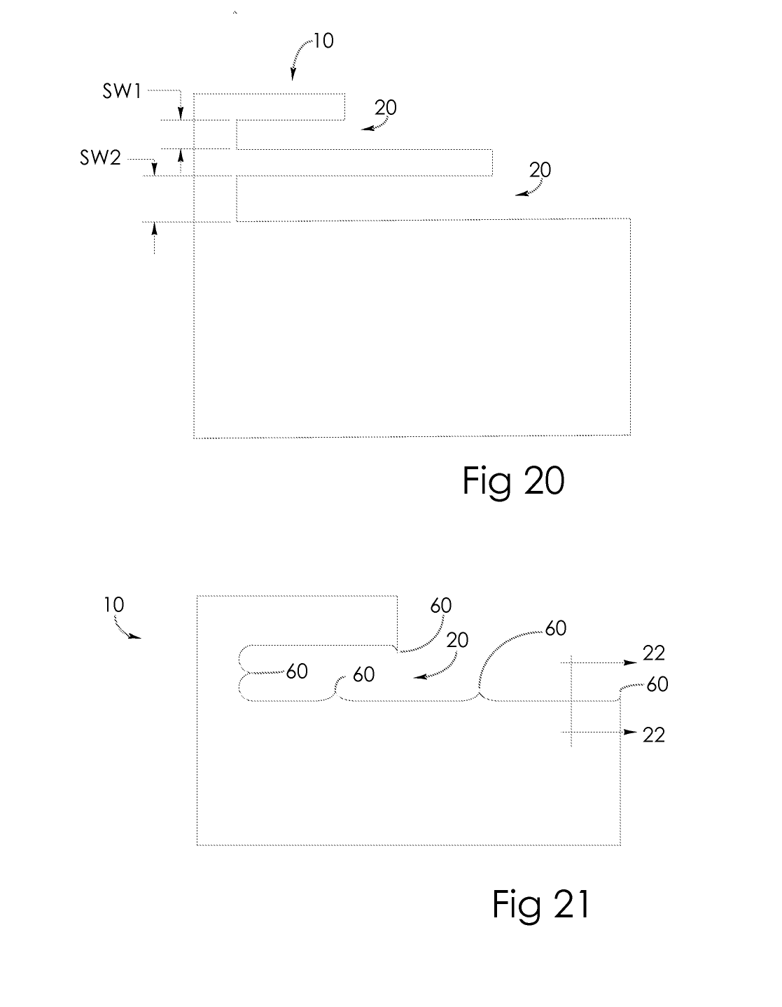

Another way to get two slot widths on one device is shown in FIG. 20. As shown slots 20 can be “stacked” on top of the one another. As shown in FIG. 20, for example, SW1 could be sized to handle “5/4” deck lumber. SW1 could be about 1½ inches, for example. Slot width 2 SW2 could be sized to handle “2×4's” (or 2×6's, 2×8's, etc.) and could be about 1¾ inches, for example.

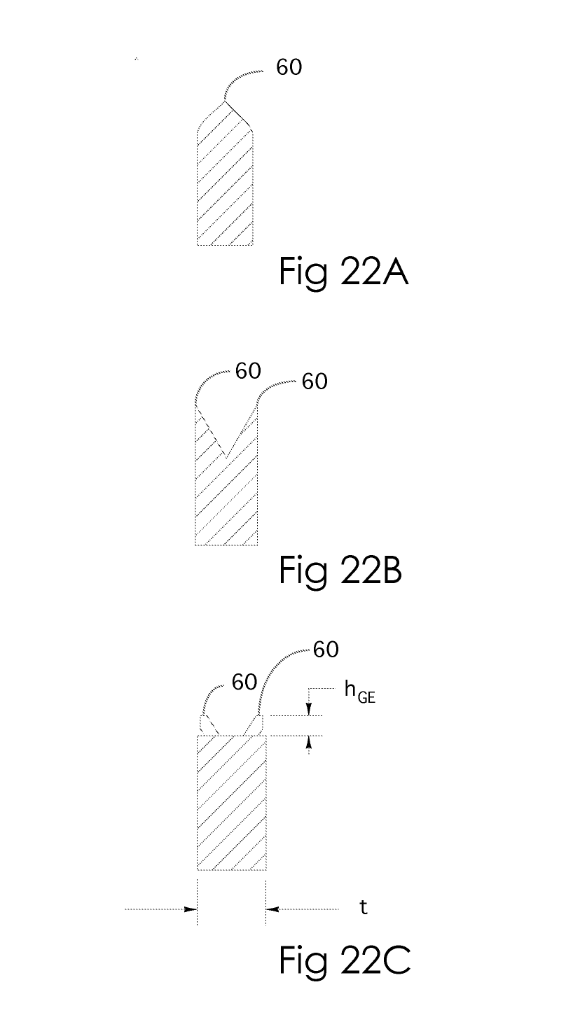

In an embodiment, stabilizing device 10 incorporates gripping elements 60 that can “dig in” or “bite” into a work piece to help keep device 10 from slipping relative to the work piece during use. A stabilizing device can use one or more gripping elements 60; five are depicted at representative locations in FIG. 21 as raised, pointed tips. Gripping elements 60 can be any relatively sharp or abrasive surface or protrusion that helps prevent movement of work piece 40 relative to stabilizing device 10 during use. Gripping elements can have a height, hGE, as shown in FIG. 22 of between about 1/32 inch and about ¼ inch, depending on the requirements of the intended work piece for slot 20. As shown in FIG. 22 A-C, gripping elements can be a simple pointed ridge formed at predetermined locations on an edge 16 (FIG. 22A), or sharpened edges of a portion of edge 16 (FIG. 22B), or sharpened members, such as nail tips, embedded in a molded plastic edge 16 (FIG. 22C). Of course, many other configurations of gripping elements 60 can be envisioned and manufactured without departing from the scope of the invention.

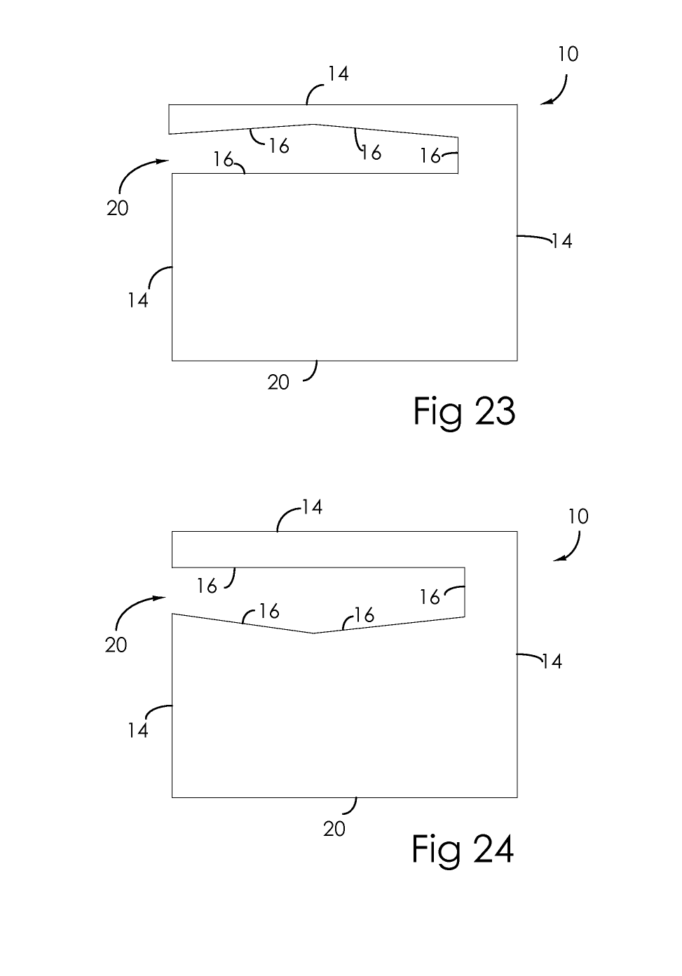

In an embodiment, slot 20 can have generally non-parallel opposing edges 16, as shown in FIGS. 23 and 24. Both FIGS. 23 and 24 show a stabilizing device 10 of generally polygonal shape, having a slot 20 defined by at least 4 edges 16. That is, as shown, one or both of top or bottom edges 16 (in relation to an in-use position with slot 20 generally parallel to a horizontal axis H and bottom edge 12) can have a deflection point such that two edges 16 slope to a point, forming a V-shape or the like. As can be understood by considering a work piece 40 inserted in slot 20 and generally centered over (or under) the generally V-shaped portion of the slot 20, in use the sloped edges 16 would contact a work piece in a smaller area along a work piece edge, thereby applying a greater pressure and providing for greater tendency for edge 16 to “bite,” “dig in,” or otherwise grab onto work piece 40 more securely.

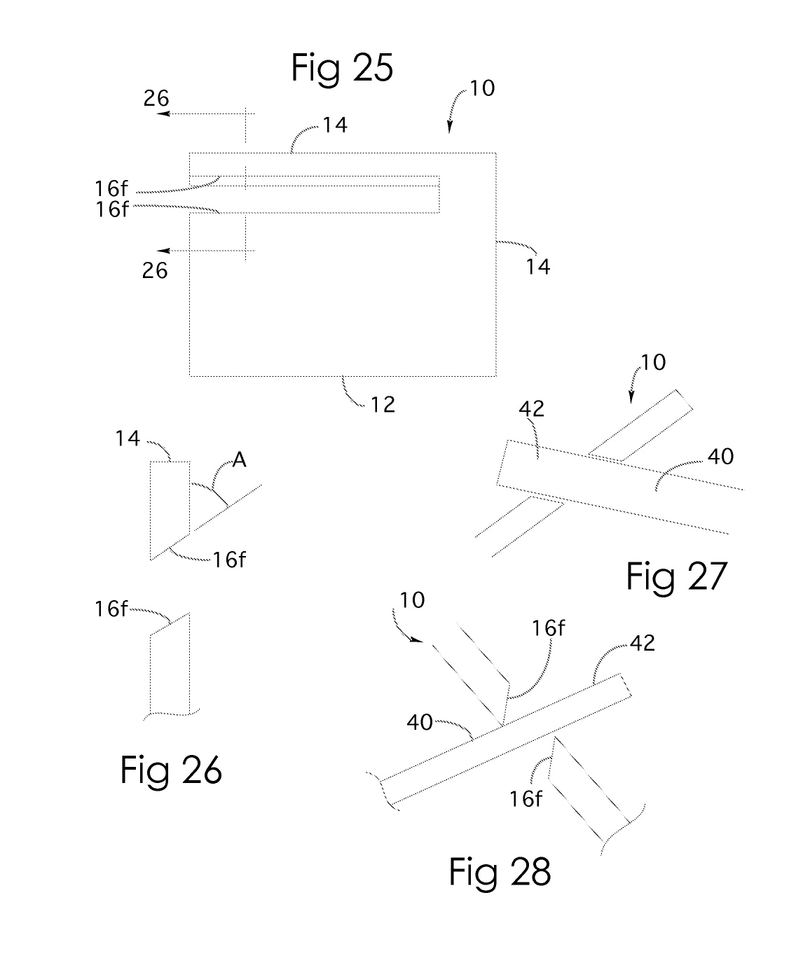

In some situations, for example when cutting relatively smooth, fine wood, it may not be desirable for stabilizing device 10 to “bite” into the wood and therefore leave a mark. For this situation, and embodiment as shown in FIG. 25 can be utilized. As shown in FIG. 25, opposing edges 16 can have beveled surfaces 16f. Beveled surfaces 16f can be generally parallel to one another, each beveled at an angle A of any suitable angle, for example, from about 30 to 60 degrees, such that in use, as shown in FIG. 27, beveled surfaces 16f contact work piece 40 in a generally flat, face to face relationship, providing a larger surface area in contact with the work piece, which results in less deformation of work piece 40 when the binding effect of the stabilizing device 10 is realized.

Of course, as shown in FIG. 28, a stabilizing device having beveled edges 16f can be used in the opposite configuration, in which the relatively sharp edges of beveled edges 16f provide for extra “digging” capability to provide even better stability to a work piece 40.

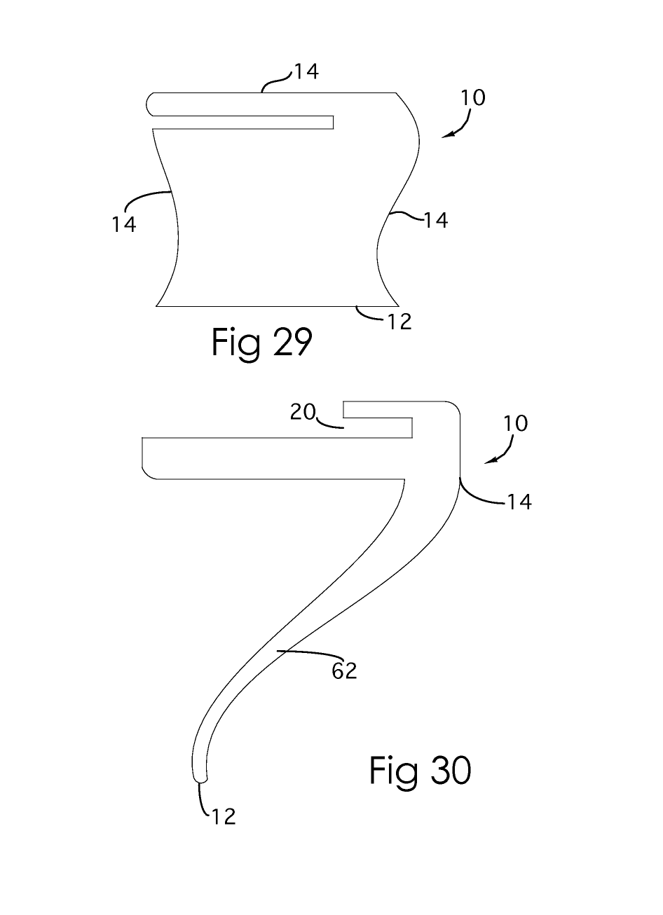

Further variations can be made without departing from the scope of the invention. For example, as shown in FIG. 29, the invention need not have purely straight polygonal sides. Some side edges, such as vertical edges (vertical with respect to vertical axis V) can be curvilinear. Top edge 14 can also be curvilinear, as can bottom edge 12. Also, as mentioned before, putting a radius on edges, rounding corners, and the like can also be done without departing from the scope of the invention.

In an embodiment, stabilizing device can have a configuration as shown in FIG. 30, in which a lower portion 62 tapers to a relatively small lower edge 12. Lower edge 12 can be offset with respect to an outer edge 14, such that in use lower portion functions as a supporting “leg”. Four such devices could be used with a generally broad, flat work piece to form a table with four legs, the legs being under the work piece.

It is understood that any of the above-disclosed features and benefits can be combined in a device with other above-disclosed features and benefits, even if they were not disclosed in the same embodiment. Thus, by way of example, a notch 22, as shown in FIG. 9, can be combined with one or more of the slots 20 in a two-slot version as shown in FIG. 17. Such combinations of features is considered disclosed herein.

What is claimed is:

1. A stabilizing device, said device having a generally planar, polygonal shape defined by edges forming a perimeter, a vertical axis and a horizontal axis, said device comprising:
a. at least one ground-contact edge generally parallel to said horizontal axis, said ground-contacting edge being in contact with the ground when the device is in use;
b. at least three edges defining an open-ended slot, said slot being oriented generally parallel to said horizontal axis.

2. The stabilizing device of claim 1, wherein said slot has a slot width defined by two opposing edges of said slot, said slot width being at least about 0.5 inch.

3. The stabilizing device of claim 1, wherein said slot has a slot width defined by two opposing edges of said slot, said slot width being at least about ⅛ inch greater than a standard dimension of standard cut lumber.

4. The stabilizing device of claim 1, wherein said device further includes at least one closed aperture.

5. The stabilizing device of claim 1, wherein said device includes no closed apertures.

6. The stabilizing device of claim 1, wherein said slot has a slot width defined by two opposing edges of said slot and a slot length, said slot width being from 10% to 30% greater than a thickness dimension of a work piece, and said slot length being from 20% to 150% of the width dimension of a work piece.

7. The stabilizing device of claim 1, further comprising a raised element on a lower edge of said slot, said raised element disposed on said edge at a position to hinder lateral movement of a work piece in said slot.

8. The stabilizing device of claim 1, comprising two or more said slots.

9. The stabilizing device of claim 1, wherein said slot comprises an enlarged area defined by at least one sloping edge portion of said slot, said slot being configured to hold a work piece of rectangular cross section in two orientations.

10. The stabilizing device of claim 1, wherein said slot has a stepped configuration defining at least two slot widths.

11. The stabilizing device of claim 1, said device further comprising reinforcing means on a top region of said device above said slot.

12. The stabilizing device of claim 1, further comprising at least one gripping element on at least one edge of said slot.

13. The stabilizing device of claim 1, wherein opposing edges of said slot are not parallel.

14. The stabilizing device of claim 1, wherein at least two edges of said slot form a V-shape.

15. The stabilizing device of claim 1, wherein at least one edge of said slot comprises a beveled surface.

16. The stabilizing device of claim 1, wherein said device comprises at least one non-linear edge.
